(19) United States
(12) Patent Application Publication
(10) Pub. No.: US 2004/0054905 A1
(43) Pub. Date: Mar. 18, 2004

(54) Local private authentication for semi-public LAN

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 10/234,682

(22) Filed: Sep. 4, 2002

(51) Int. Cl. H04L 9/00

(52) U.S. Cl. 713/171

(57) ABSTRACT

A local private authentication system for a semi-public LAN is provided through introduction local to the semi-public LAN of authentication servers dedicated to foreign provider domains. Such a local private authentication system authenticates members of foreign provider domains solely with local message exchanges, thereby reducing authentication delays. Such a local private authentication service further authenticates members of foreign provider domains with authentication servers dedicated to foreign provider domains, thereby protecting member privacy.

### BACKGROUND OF THE INVENTION

Many airports, cafes, hotels, libraries, shopping malls and other places of public accommodation have recently installed or are in the process of installing local area network (LAN) architectures which provide Internet access to roaming users. A significant challenge facing widespread adoption and use of such “semi-public LANS,” or “Internet hot spots,” is authentication, authorization and accounting (AM). Particularly, semi-public LANs must be able to regulate access such that only authorized persons are allowed access, and must further be able to track usage by such authorized persons for billing purposes. This presents difficult challenges since semi-public LANs are not the home provider domain of most of their users. Rather, most users of semi-public LANs are members of foreign provider domains that have service contracts with the semi-public LAN.

One known technique for providing AM services in semi-public LANs to members of foreign provider domains Is remote peering. To accomplish the “authentication” part of AAA service provisioning through remote peering, a remote authentication server In the foreign provider domain exchanges authentication session messages with a local authentication server in the semi-public LAN domain. Providing an authentication service in this manner has significant drawbacks. First, the remote authentication session message exchanges lead to authentication delays. Second, the sharing of authentication information outside the foreign provider domain compromises member privacy.

### SUMMARY OF THE INVENTION

The present invention provides a local private authentication system for a semi-public LAN through introduction local to the semi-public LAN of authentication servers dedicated to foreign provider domains. Such a local private authentication system authenticates members of foreign provider domains solely with local message exchanges, thereby reducing authentication delays. Such a local private authentication service further authenticates members of foreign provider domains with authentication servers dedicated to foreign provider domains, thereby protecting member privacy.

In one aspect, an authentication system for a semi-public LAN comprises a first node being used by a member of a foreign provider domain; a second node communicating with the first node over a LAN link; and an authentication server communicating with the second node, wherein the member of the foreign provider domain is authenticated in an authentication session involving the first node, the second node and the authentication server and wherein the authentication session is conducted solely with local message exchanges.

In another aspect, an authentication system for a semi-public LAN comprises a first node being used by a member of a foreign provider domain; a second node communicating with the first node over a LAN link; and a local authentication server communicating with the second node, wherein the member of the foreign provider domain is authenticated In an authentication session involving the first node, the second node and the local authentication server and wherein the local authentication server is dedicated to the foreign provider domain.

In another aspect, an authentication system for a semi-public LAN comprises a first node; a second node communicating with the first node over a LAN link; and a plurality of local authentication servers interconnected to the second node, wherein In response to provider information supplied by the first node, a third node determines one of the plurality of local authentication servers for conducting an authentication session with the first node.

These and other aspects of the present invention will be better understood by reference to the detailed description of the preferred embodiment read in conjunction with the drawings briefly described below. Of course, the scope of the invention is defined by the appended claims.

### BRIEF DESCRIPTION OF THE DRAWINGS

FIG. 1 is a block diagram illustrating a network in accordance with a first embodiment of the invention;

FIG. 2 is a block diagram illustrating a roaming end-station in accordance with the Invention;

FIG. 3 is a block diagram illustrating an access point in accordance with the invention;

FIG. 4 is a block diagram illustrating a local authentication station in accordance with the first embodiment;

FIG. 5 is a flow diagram illustrating an authentication session message exchange in accordance with the invention;

FIG. 6 is a flow diagram illustrating back-end processing of an authentication session message in accordance with the invention;

FIG. 7 is a block diagram illustrating a network in accordance with a second embodiment of the Invention; and

FIG. 8 is a block diagram illustrating a local authentication service in accordance with the second embodiment.

### DETAILED DECRIPTION OF THE PREFERRED EMBODIMENT

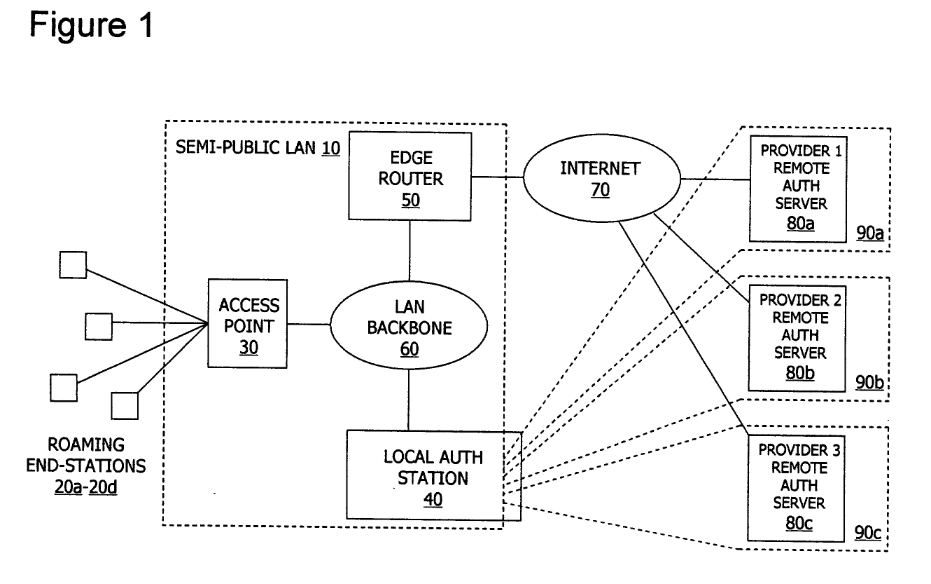

In FIG. 1, a network in accordance with a first preferred embodiment of the invention is shown. The network Includes semi-public LAN 10 interconnected over the Internet 70 to foreign provider remote authentication servers 80a, 80b, 80c which are within foreign provider domains 90a, 90b, 90c, respectively. Foreign providers are entities, such as Internet service providers (ISPS), corporations and other organizations, having arrangements with semi-public LAN 10 to provide Internet access for their roaming members. Semi-public LAN 10 Includes access point 30, shared elements of local authentication station 40, and edge router 50, all of which are interconnected over LAN backbone 60. As described In more detail below, dedicated elements of local authentication station 40, namely, provider local authentication servers, are local to semi-public LAN 10 but are within foreign provider domains 90a, 90b, 90c. Semi-public LAN 10 provides roaming end-stations 20a, 20b, 20c, 20d being used by roaming members of foreign provider domains 90a, 90b, 90caccess to the Internet 70 via access point 30 upon authenticating on local authentication station 40 credentials of such roaming users. End-stations 20a, 20b, 20c, 20d communicate with access point 30 via a LAN connection, such as an IEEE 802.11-compliant wireless Ethernet link. Access point 30 and local authentication station 40 communicate over a preconfigured secure connection using known addresses and encryption keys. Local authentication station 40 and remote authentication servers 80a, 80b, 80c also communicate over respective preconfigured secure connections using known addresses and encryption keys.

The elements and functions described herein may be implemented using hardware, software or a combination of hardware and software, including but not limited to hardwired logic such as application specific integrated circuits (ASICs), software-driven logic such as general purpose processors and software applications.

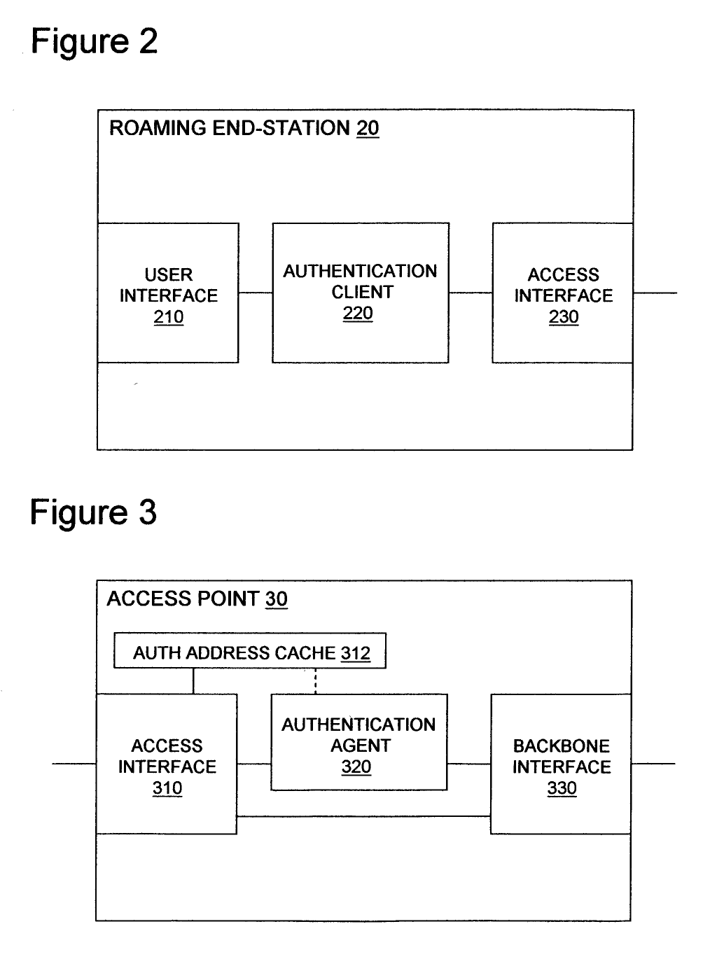

Turning to FIG. 2, roaming end-station 20, which is representative of roaming end-stations 20a, 20b, 20c, 20d, is shown. End-station 20 is a network node that Includes user Interface 210, authentication client 220 and access interface 230.

User interface 210 displays graphical and textual information for viewing by the roaming member of a foreign provider domain who is using end-station 20. Displayed graphical and textual information includes user login prompts, user responses to user login prompts and authentication success/failure notices.

Authentication client 220 participates in authentication sessions on behalf of end-station 20 in attempts to authenticate the roaming member of the foreign provider domain who is using end-station 20. Client 220 performs authentication session Initiation and authentication session message processing. Client 220 may perform, for example, the supplicant port access entity (PAE) role defined in IEEE Standard 802.1X (2001). Client 220 initiates an authentication session after end-station 20 has associated with access point 30. Client 220 initiates an authentication session by transmitting an authentication session START message to access point 30. Client 220 also responds to authentication session messages received from access point 30 in the authentication session, soliciting information from the roaming user via user Interface 210 as required.

Access interface 230 is a LAN interface, such as an IEEE 802.11-compliant wireless LAN interface, which performs physical layer, media access control (MAC), association and encryption functions for end-station 20. Physical layer functions Include transmitting and receiving wireless LAN signals. MAC functions include looking up the destination MAC address in inbound messages to determine if end-station 20 is an intended recipient. Association functions include exchanging MAC addresses and an association encryption key with access point 30. Encryption functions include using the association encryption key and data session encryption keys to encrypt and decrypt message information exchanged with access point 30. The association encryption key is used for encrypting and decrypting message information exchanged with access point 30 during authentication sessions. The data encryption keys are used for encrypting and decrypting message information exchanged with access point 30 during post-authentication data sessions.

Turning to FIG. 3, access point 30 is shown in greater detail. Access point 30 is a network node that includes access interface 310, authentication agent 320 and backbone interface 330.

Access interface 310 is a LAN Interface, such as an IEEE 802.11-compliant wireless LAN interface, which performs physical layer, MAC, association, encryption and LAN protocol translation functions for access point 30. Physical layer functions include transmitting and receiving wireless LAN signals on wireless LAN connections. MAC functions Include looking up in authenticated address cache 312 the source MAC address in messages received from end-stations 20a, 20b, 20c, 20d to determine whether the originating one of end-stations 20a, 20b, 20c, 20d is being used by an authenticated roaming user. MAC functions further Include looking up in authenticated address cache 312 the destination MAC address in messages received from backbone interface 330 to determine whether the intended recipient one of end-stations 20a, 20b, 20c, 20d is being used by an authenticated roaming user. MAC addresses are recognized as being associated with authenticated roaming users or not by their presence or lack of presence in authenticated address cache 312. Association functions include exchanging MAC addresses and an association encryption key with end-stations 20a, 20b, 20c, 20d. Encryption functions include using the association encryption key and data encryption keys to encrypt and decrypt message information exchanged with end-stations 20a, 20b, 20c, 20d. The association encryption key is used for encrypting and decrypting message information exchanged with end-stations 20a, 20b, 20c, 20d during authentication sessions. The data encryption keys are used for encrypting and decrypting message information exchanged with end-stations 20a, 20b, 20c, 20d during post-authentication data sessions. LAN protocol translation includes translating messages exchanged with end-stations 20a, 20b, 20c, 20d between disparate formats, such as between 802.11 wireless Ethernet and 802.3 wired Ethernet formats.

Access interface 310 processes messages as follows. Interface 310 forwards to backbone interface 330 all messages received from end-stations 20a, 20b, 20c, 20d being used by authenticated roaming users as indicated by presence of the message's source MAC address in authenticated address cache 312. Cache 312 may be implemented using content addressable memory (CAM). Interface 310 forwards to authentication agent 320 all messages originating from end-stations 20a, 20b, 20c, 20d not being used by authenticated roaming users as Indicated by absence of the message's source MAC address from authenticated address cache 312. Interface 310 forwards to intended recipient end-stations 20a, 20b, 20c, 20d all messages received from backbone interface 330 destined for end-stations 20a, 20b, 20c, 20d associated with authenticated roaming users as indicated by presence of the message's destination MAC address in cache 312. Interface 310 forwards to authentication agent 320 all messages received from backbone interface 330 not destined for end-stations 20a, 20b, 20c, 20d associated with authenticated roaming users as indicated by absence of the message's destination MAC address from cache 312. Finally, access interface 310 forwards to intended recipient end-stations 20a, 20b, 20c, 20d all messages received from authentication agent 320.

Authentication agent 320 participates in authentication sessions on behalf of access point 30 in attempts to authenticate the roaming members of foreign provider domains who are using end-stations 20a, 20b, 20c, 20d. Agent 320 performs authentication protocol translation and access control. Agent 320 may perform, for example, the authenticator PAE role defined in IEEE Standard 802.1X (2001).

Authentication agent 320 processes messages received from access interface 310 as follows. Agent 320 checks whether such messages are authentication session messages. Messages which are not authentication session messages are filtered. Messages which are authentication session messages are further checked to determine the authentication session message type. Authentication session message types received by agent 320 include START, REQUEST, RESPONSE, SUCCESS and FAILURE. Agent 320 responds to START messages by assigning an authentication session identifier and transmitting via access interface 310 to the one of end-stations 20a, 20b, 20c, 20d which originated the START message a REQUEST message requesting a provider identifier and member identifier. The assigned authentication session identifier is applied to all subsequent messages in the authentication session. Agent 320 responds to REQUEST, SUCCESS and FAILURE messages by translating such messages for processing at the intended recipient one of end-stations 20a, 20b, 20c, 20d and forwarding such messages to access interface 310. Where end-stations 20a, 20b, 20c, 20d communicate with access point 30 on a LAN connection and local authentication station 40 supports Remote Authentication Dialup User Service (RADIUS) authentication, for example, translation of REQUEST, SUCCESS and FAILURE messages may be from Extensible Authentication Protocol (EAP) over RADIUS format to EAP over LAN (EAPOL) format. Agent 320 responds to RESPONSE messages by translating such messages for processing at local authentication station 40 and forwarding such messages to backbone interface 330. Where end-stations 20a, 20b, 20c, 20d communicate with access point 30 on LAN connections and local authentication station 40 supports RADIUS authentication, for example, translation of RESPONSE messages may be from EAPOL format to EAP over RADIUS format. Authentication agent 320 further, in response to SUCCESS messages, stores in authenticated address cache 312 on access interface 310 (through a transmission on a management line shown as a dashed line in FIG. 3) the destination MAC address from the SUCCESS message. Authentication agent 320 further, in response to a SUCCESS message, transmits via access interface 310 to the intended recipient one of end-stations 20a, 20b, 20c, 20d a KEY message including unicast and multicast data encryption keys.

Backbone Interface 330 is a LAN Interface, such as an IEEE 802.3-compliant wired LAN interface, which performs physical layer functions for access point 30. Physical layer functions include transmitting and receiving wired LAN signals on wired LAN connections. Backbone Interface 330 forwards on LAN backbone 60 all messages received from authentication agent 320 and forwards to access interface 310 all messages received from LAN backbone 60.

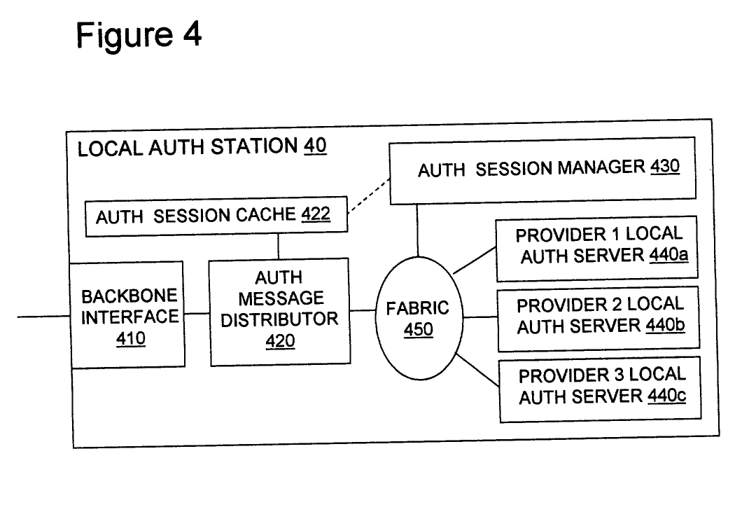

Turning to FIG. 4, local authentication station 40 is shown in greater detail. Local authentication station 40 is a network node that includes authentication message distributor 420, authentication session manager 430 and provider local authentication servers 440a, 440b, 440cInterconnected via fabric 450. Authentication message distributor 420 is also interconnected to backbone interface 410 and authentication session cache 422.

Backbone interface 410 Is a LAN Interface, such as an IEEE 802.3-compliant wired LAN interface, which performs physical layer functions for local authentication station 40. Physical layer functions include transmitting and receiving wired LAN signals on wired LAN connections. Backbone interface 410 forwards to authentication message distributor 420 all messages received from LAN backbone 60 and forwards on LAN backbone 60 all messages received from authentication message distributor 420.

Authentication message distributor 420 directs messages received from LAN backbone 60 to authentication session manager 430 or an appropriate one of provider local authentication servers 440a, 440b or 440cvia fabric 450. Authentication message distributor 420 also “snoops” messages received from fabric 450 to identify authentication session termination.

Authentication message distributor 420 processes messages received from backbone interface 410 as follows. Distributor 420 checks whether such messages are RESPONSE messages. Messages which are not RESPONSE messages are forwarded to authentication session manager 430. RESPONSE messages are further checked to determine whether such messages are associated with an active authentication session. RESPONSE messages associated with an active authentication session are resolved to such session and forwarded directly to the one of provider local authentication servers 440a, 440b, 440cinvolved in such session. Fabric 450 may be implemented using numerous known switching fabric architectures and algorithms, such as a time-division multiplex bus with round-robin arbitration or a dedicated point-to-point connection mesh.

The check to determine whether RESPONSE messages are associated with an active authentication session, and resolution of the active session if any, are facilitated by authentication session cache 422. Cache 422 includes entries associating authentication session identifiers of active authentication sessions with ones of provider local authentication servers 440a, 440b, 440cinvolved in active authentication sessions. Distributor 420 looks-up authentication session identifiers from RESPONSE messages in authentication session cache 422. If a session Identifier Is found In cache 422, the session Is active and the RESPONSE message is forwarded directly to the associated one of provider local authentication servers 440a, 440b, 440c. If no session identifier is found in cache 422, the session is not yet active and the RESPONSE message is forwarded to authentication manager 430 for resolution of one of provider local authentication servers 440a, 440b, 440c. Cache 422 may be implemented using random access memory (RAM).

Authentication message distributor 420 processes messages received from fabric 450 as follows. Distributor 320 “snoops” the messages to determine whether they are SUCCESS or FAILURE messages. Messages which are not SUCCESS or FAILURE messages are forwarded directly to backbone interface 410. Messages which are SUCCESS or FAILURE messages are further checked for the authentication session identifier. Distributor 420 deletes from cache 422 the entry for the session identifier and forwards the message to backbone Interface 410. Active authentication sessions are thusly deactivated on station 40.

Authentication session manager 430 directs messages received from authentication message distributor 420 to an appropriate one of provider local authentication servers 440a, 440b, 440cvia fabric 450. Authentication session manager 430 also identifies authentication session initiation.

Authentication session manager 430 processes messages received from authentication message distributor 420 as follows. Manager 430 checks whether messages received from distributor 420 are RESPONSE messages. Messages which are not RESPONSE messages are resolved to ones of provider local authentication servers 440a, 440b, 440cbased on routing information, such as IP addresses and TCP port numbers, contained in such messages and forwarded via fabric 450 to such ones of provider local authentication servers 440a, 440b, 440c. Such non-RESPONSE messages may include, for example, messages associated with management updates of provider local authentication servers 440a, 440b, 440coriginating from provider remote authentication servers 80a, 80b, 80c, respectively. Notably, such management update messages are not part of authentication sessions and the time of their transmission and their contents is independent thereof. RESPONSE messages are resolved to ones of provider local authentication servers 440a, 440b, 440cbased on a provider identifier (e.g. provider.com) from such messages and are forwarded via fabric 450 to the resolved ones of provider local authentication servers 440a, 440b, 440c. Manager 430 maintains configured IP/TCP-to-provider local authentication server associations, and provider identifier-to-provider local authentication server associations, to assist in determining provider local authentication servers for message forwarding. Prior to forwarding RESPONSE messages, such messages are further checked for the authentication session identifier and an entry associating the authentication session identifier with the determined one of provider local authentication servers 440a, 440b, 440cis stored in authentication session cache 422 (through a transmission on a management line shown as a dashed line in FIG. 4). Authentication sessions are thusly activated on station 40.

Provider local authentication servers 440a, 440b, 440cconduct authentication sessions with roaming members of their respective foreign provider domains 90a, 90b, 90cwho are using end-stations 20a, 20b, 20c, 20d to authenticate such members, and notify authentication agent 320 of changes in the authentication states of end-stations 20a, 20b, 20c, 20d based on results of such authentication sessions. Provider local authentication servers 440a, 440b, 440cmay perform, for example, the authentication server role defined in IEEE Standard 802.1X (2001) and may be RADIUS servers. Provider local authentication servers 440a, 440b, 440cinclude respective member databases (not shown) having authentication information for members of their respective foreign provider domains 90a, 90b, 90cwho are authorized to use semi-public LAN 10. Each member database entry maintains a member identifier, an authentication method and a credential. A member Identifier includes, for example, a member name (e.g. john.doe). An authentication method includes, for example, an indication of the type of credential to be requested of the member in an authentication session. A credential includes, for example, a password, digital certificate or the like required to be supplied by the member and verified for successful authentication. Member databases of provider local authentication servers 440a, 440b, 440care updated via management update messages originating from provider remote authentication servers 80a, 80b, 80c, respectively.

Importantly, provider local authentication servers 440a, 440b, 440care dedicated resources of remote provider domains 90a, 90b, 90c, respectively. Provider 1 local authentication server 440a receives management updates only from remote provider authentication server 80a and conducts authentication sessions only with ones of end-stations 20a, 20b, 20c, 20d being used by roaming users whose home domain is provider 1. Provider 2 local authentication server 440b receives management updates only from remote provider authentication server 80b and conducts authentication sessions only with ones of end-stations 20a, 20b, 20c, 20d being used by roaming users whose home domain is provider 2. Provider 3 local authentication server 440creceives management updates only from remote provider authentication server 80c and conducts authentication sessions only with ones of end-stations 20a, 20b, 20c, 20d being used by roaming users whose home domain is provider 3. Thus, provider local authentication servers 440a, 440b, 440care within foreign provider domains 90a, 90b, 90c, respectively. Of course, in other embodiments of the invention there may be different numbers of providers and corresponding different numbers of dedicated provider local authentication servers.

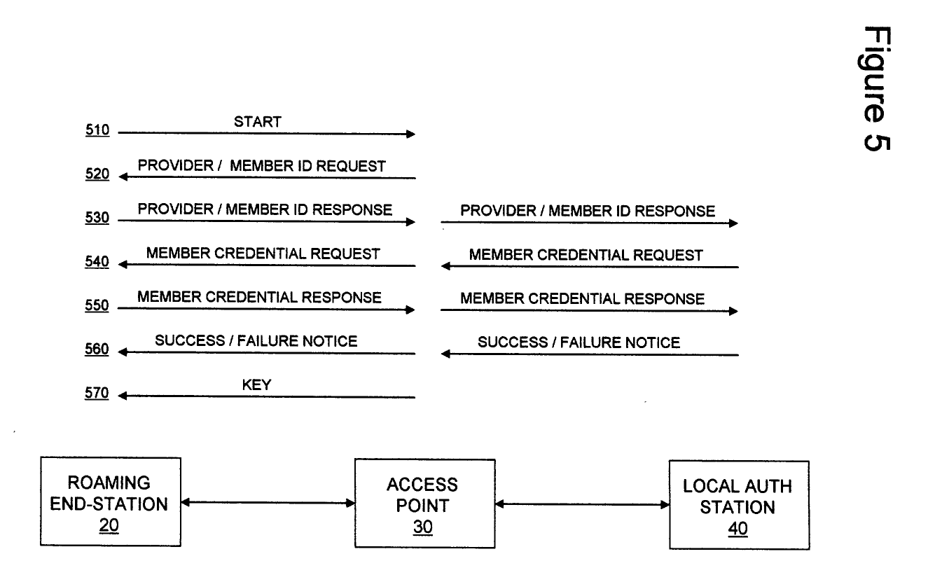

Turning now to FIG. 5, an exemplary authentication session message exchange in accordance with the first embodiment is shown. Roaming end-station station 20 associated with access point 30 transmits an authentication session START message to access point 30 requesting to initiate an authentication session (510). Access point 30 assigns an authentication session identifier and responds with a REQUEST message requesting a provider identifier and a member identifier (520). All further messages In the authentication session are tagged with the authentication session identifier. End-station 20 responds with a RESPONSE message including a provider identifier and a member identifier (e.g. john.doe@provider.com). Access point 30 relays the RESPONSE message to local authentication station 40 (530). As the authentication session identifier is not yet associated with an active session, the authentication session identifier is not found In authentication session cache 422 and the message is forwarded to authentication session manager 430. Manager 430 looks-up the provider identifier (e.g. provider.com) and directs the RESPONSE message to the prescribed one of provider local authentication servers 440a, 440b, 440c. Manager 430 further adds an entry to authentication session cache 422 associating the authentication session identifier and the provider local authentication server. The provider local authentication server looks-up the member identifier (e.g. john.doe) and determines a prescribed authentication method and required credential. The provider local authentication server responds with a REQUEST message requesting a credential in accordance with the authentication method. Access point 30 relays the REQUEST message to end-station 20 (540). End-station 20 responds with a RESPONSE message including a credential In accordance with the authentication method. Access point 30 relays the RESPONSE message to local authentication station 40 (550). As the authentication session Identifier Is now associated with an active session, the authentication session identifier is found in authentication session cache 422 and authentication message distributor 420 forwards the RESPONSE message directly to the provider local authentication server. The provider local authentication server attempts to verify the credential. If the attempt to verify the credential is successful, the provider local authentication server responds with a SUCCESS message. Access point 30 In that event adds the destination MAC address from the SUCCESS message to authenticated address cache 312 and relays the SUCCESS message to end-station 20 (560). Access point 30 further in that event transmits a KEY message including the data encryption keys to end-station (570). If the attempt to verify the credential is unsuccessful, the provider local authentication server responds with a FAILURE message. Access point 30 in that event relays the FAILURE message to end-station 20 (560).

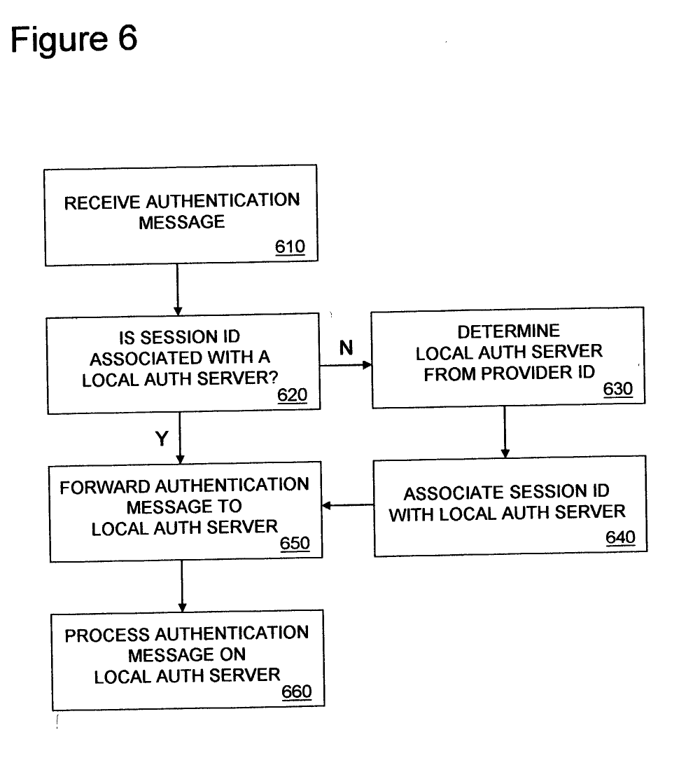

Turning to FIG. 6, a flow diagram illustrating back-end processing of an authentication session message in accordance with the invention is shown. An authentication session message is received (610). A check is made to determine if the authentication session identifier is associated with a provider local authentication server (620). If the authentication session identifier is associated with a provider local authentication server, the authentication session message is forwarded to the provider local authentication server (650) and processed on the local authentication server (660). If, however, the authentication session identifier is not associated with a provider local authentication server, a provider local authentication server is determined from a provider identifier in the message (630) and the session identifier becomes associated with the provider local authentication server (640) prior to forwarding the message to the provider local authentication server (650) and processing the message thereon (660).

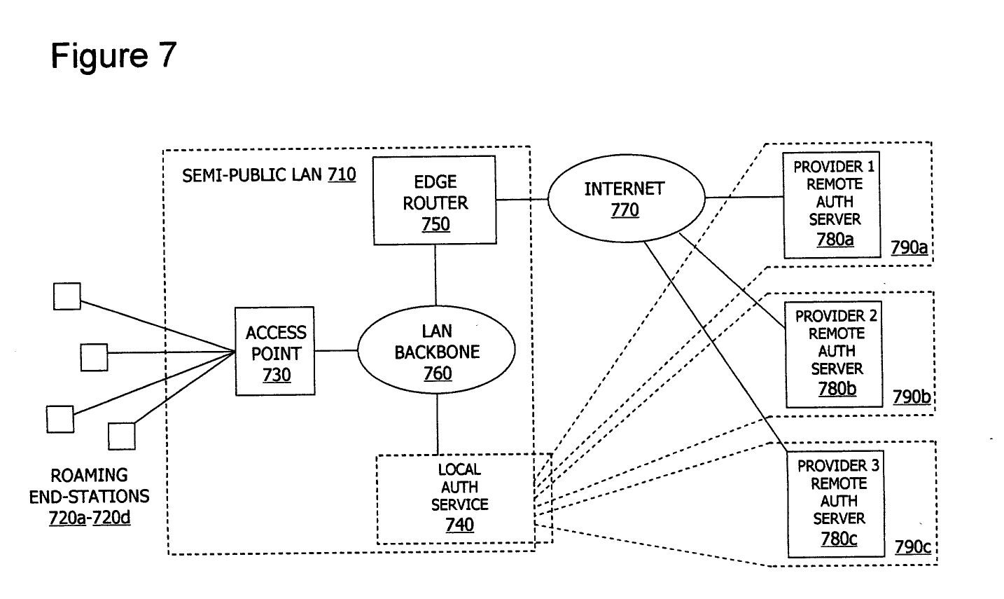

Turning to FIG. 7, a network in accordance with a second preferred embodiment of the invention is shown. The second preferred embodiment is similar to the first preferred embodiment except that a back-end local authentication service 740 is distributed across multiple network nodes. The network includes semi-public LAN 710 interconnected over the Internet 770 to foreign provider remote authentication servers 780a, 780b, 780c which are within foreign provider domains 790a, 790b, 790c, respectively. Semi-public LAN 710 includes access point 730, shared elements of local authentication service 740, and edge router 750 interconnected over LAN backbone 760. Dedicated elements of local authentication service 740, namely, provider local authentication server nodes, are within foreign provider domains 790a, 790b, 790c. Semi-public LAN 710 provides roaming end-stations 720a, 720b, 720c, 20d being used by roaming members of foreign provider domains 790a, 790b, 790caccess to the Internet 770 via access point 730 upon authenticating using local authentication service 740 credentials of such roaming users. End-stations 720a, 720b, 720c, 720d communicate with access point 730 via a LAN connection, such as an IEEE 802.11-compliant wireless Ethernet link. Access point 730 and local authentication service 740 communicate over respective preconfigured secure connections using known addresses and encryption keys. Local authentication service 740 and remote authentication servers 780a, 780b, 780c also communicate over respective preconfigured secure connections using known addresses and encryption keys.

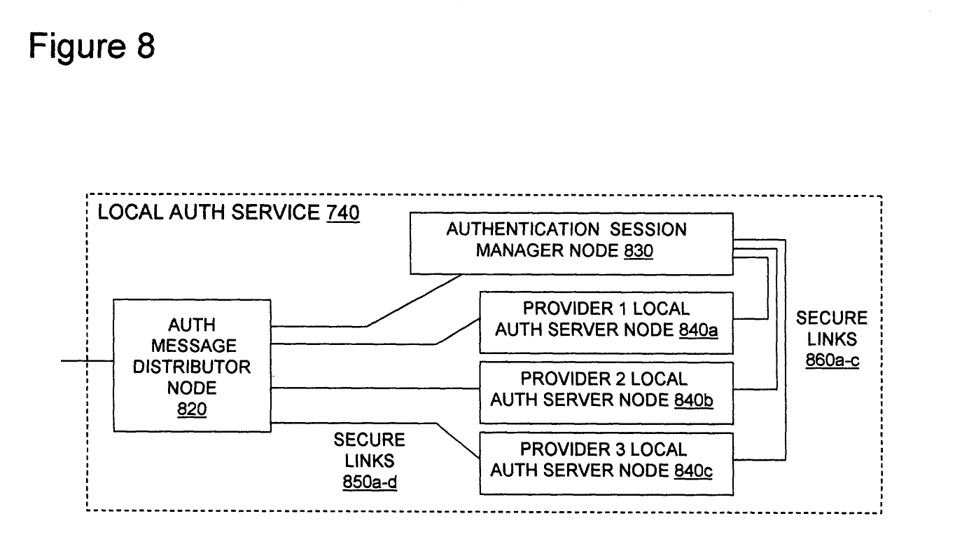

Turning to FIG. 8, local authentication service 740 is shown in greater detail. Local authentication service 740 Includes secure links 850a, 850b, 850c, 850d interconnecting authentication message distributor node 820 to provider local authentication server nodes 840a, 840b, 840cand authentication session manager node 830, respectively. Local authentication service 740 also includes secure links 860a, 860b, 860cinterconnecting authentication session manager node 830 and provider local authentication server nodes 840a, 840b, 840c, respectively. Authentication message distributor node 820 has an internal backbone interface to LAN backbone 760 and an internal authentication session cache (not shown).

Processing between nodes 820, 830, 840a, 840b, 840cin local authentication service 740 proceeds in a manner similar to previously described processing between elements 420, 430, 440a, 440b, 440con local authentication station 40, except as follows: Authentication session messages are transmitted on preconfigured secure links 850a, 850b, 850c, 850d, 860a, 860b, 860c. Authentication session cache updates are transmitted on preconfigured secure link 850d. Management updates originating from provider remote authentication servers 780a, 780b, 780c are transmitted directly to provider local authentication server nodes 840a, 840b, 840c, respectively, on preconfigured secure links (not shown).

It will be appreciated by those of ordinary skill in the art that the invention may be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof is intended to be embraced therein.

I claim:

1. An authentication system for a semi-public LAN, comprising:
a first node being used by a member of a foreign provider domain;
a second node communicating with the first node over a LAN link; and
an authentication server communicating with the second node,
wherein the member of the foreign provider domain is authenticated in an authentication session involving the first node, the second node and the authentication server and wherein the authentication session is conducted solely with local message exchanges.

2. The system of claim 1, wherein the authentication server is dedicated to the foreign provider domain.

3. The system of claim 1, wherein the authentication server is determined from a plurality of authentication servers In response to provider information supplied by the first node.

4. An authentication system for a semi-public LAN, comprising:
a first node being used by a member of a foreign provider domain;
a second node communicating with the first node over a LAN link; and
a local authentication server communicating with the second node,
wherein the member of the foreign provider domain is authenticated in an authentication session involving the first node, the second node and the local authentication server and wherein the local authentication server is dedicated to the foreign provider domain.

5. The system of claim 1, wherein the authentication session is conducted solely with local message exchanges.

6. The system of claim 1, wherein local authentication server is determined from a plurality of local authentication servers in response to provider domain supplied by the first node.

7. An authentication system for a semi-public LAN, comprising:
a first node;
a second node communicating with the first node over a LAN link; and
a plurality of local authentication servers Interconnected to the second node, wherein in response to provider information supplied by the first node, a third node determines one of the plurality of local authentication servers for conducting an authentication session with the first node.

8. The system of claim 7, wherein the authentication session is conducted solely with local message exchanges.

9. The system of claim 7, wherein the first node is being used by a member of a foreign provider domain.

10. The system of claim 9, wherein the determined one of the plurality of local authentication servers is dedicated to the foreign provider domain.

11. The system of claim 9, wherein the member Is authenticated in the authentication session.

12. An authentication node, comprising:
a plurality of authentication servers; and
a message distribution system for forwarding an authentication session message to one of the plurality of authentication servers in response to information in the authentication session message.

13. The node of claim 12, wherein the Information is provider information.

14. The node of claim 12, wherein the Information is authentication session information.

15. The node of claim 12, wherein the plurality of authentication servers are dedicated to a respective plurality of foreign provider domains.

16. The node of claim 15, wherein the plurality of authentication servers are updated by a respective second plurality of authentication servers dedicated to the respective plurality of foreign provider domains.

17. The node of claim 12, wherein the plurality of authentication servers are local.

18. The node of claim 17, wherein the plurality of authentication servers are updated by a respective plurality of remote authentication servers.
